(19) United States
(12) Patent Application Publication
(10) Pub. No.: US 2002/0087343 A1
(43) Pub. Date: Jul. 4, 2002

(54) Computer-implemented method and apparatus for providing an interface to shipping and tracking systems

(76) Inventor: Lee Reid, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 09/969,120

(22) Filed: Oct. 1, 2001

Related U.S. Application Data
(60) Provisional application No. 60/237,019, filed on Sep. 29, 2000.

(51) Int. Cl. G06F 17/60

(52) U.S. Cl. 705/1

(57) ABSTRACT

A flowchart-based industrial control system executes a process that involves transportation of goods and includes a computer and a controller. A device such as an Internet communication link, a printer, a bar code reader, a shipping label applicator, and a diverter is connected to the controller. A flowcharting module run by the computer generates and edits flowchart source code that includes flowchart blocks and that contains logic for operating the device to further the process. A transportation flowchart block facilitates shipping of the goods. The transportation flowchart block contacts at least one shipping company and transmits shipping details concerning the goods. The transportation flowchart block evaluates responses from shipping companies and selects one of shipping companies. The transportation flowchart block requests shipping information for a shipping label from the selected shipping company, prints a shipping label, and applies the shipping label to the goods.

### CROSS-REFERENCE TO RELATED APPLICATIONS

This application claims the benefit of U.S. Provisional Application Serial No. 60/237,019, filed Sep. 29, 2000.

### FIELD OF THE INVENTION

The present invention relates generally to industrial control systems, and more particularly to industrial control systems involving the shipping of goods.

### BACKGROUND OF THE INVENTION

Industrial control systems are generally used for controlling processes that involve electrical and electromechanical devices such as relays, solenoids, motors, valves, switches, diverters, machines, and other similar devices. For example, one or more industrial control systems may be used to manage the manufacture, assembly, packaging and shipping of products by a manufacturer.

The manufacturing portion of the process may include machining, drilling, welding, spraying paint, handling materials and mixing materials. The assembly portion of the process may include sourcing the parts, handling or positioning the parts, and connecting the parts together. The packaging portion of the process may include positioning the finished goods in a package such as a box, adding packing material to the box, and closing the package with tape or adhesive. The shipping portion of the process may include contacting one or more shipping companies, requesting an air bill, printing a correct shipping label, attaching the shipping label to the package and positioning the package in a staging area for pickup by the selected shipping company.

Each of these processes can be controlled by industrial control system(s) that may include programmable logic controller(s) that are connected to a high level controller such as a personal computer. Conventional industrial control systems generally employ ladder diagrams and relay ladder logic (RLL) to control the operation of the devices that are associated with the processes. In practice, however, programmers tend to use a flowchart to define the operation of the devices in the process. The programmers manually translate the flowchart into the ladder diagrams. The programmers employ the flowcharts as a first step because the flowcharts emulate human thought processes whereas the ladder diagrams do not.

Flowcharts generally include action blocks that represent an operation or action based on current data in the control system. Action blocks may include input or output data. Action blocks generally have one entry point at the top and one exit point at the bottom. A branching or decision block is a diamond-shaped block that represents a branch in the control path based on the result of a decision. Branching blocks generally have one entry point and two exit points. Using the action and branching blocks, a programmer creates a flowchart that controls one or more devices that are associated with the process.

Flowcharts dramatically simplify the programming of the devices in the process. One suitable flowchart-based system is disclosed in “Continuous Flowchart, Improved Data Format and Debugging System For Programming and Operation of Machines”, U.S. Pat. No. 4,852,047, which is hereby incorporated by reference. Additional improvements to industrial control systems that are associated shipping and tracking of items would be desirable.

### SUMMARY OF THE INVENTION

A flowchart-based industrial control system according to the present invention executes a process that involves transportation of goods and includes a computer and a controller that is connected to the computer. A device is connected to the controller. A flowcharting module run by the computer generates and edits flowchart source code that includes flowchart blocks and contains logic for operating the device to further the process. At least one of the flowchart blocks is a transportation flowchart block that facilitates shipping of the goods.

In other features of the invention, the transportation flowchart block contacts shipping companies and transmits shipping details concerning the goods, evaluates responses from the shipping companies and selects one of the plurality of shipping companies. The transportation flowchart block requests shipping information for a shipping label from the selected shipping company.

In still other features of the invention, the device is at least one of an Internet communication link, a printer, a bar code reader, a conveyor motor, a shipping label applicator, and a diverter. The transportation flowchart block prints a shipping label with the shipping information from the selected shipping company using the printer. The transportation flowchart block applies the shipping label to the goods using the shipping label applicator.

In yet other features, the flowchart source code is converted by the flowchart module to flowchart object code that is executed by the controller. The transportation flowchart block connects to the shipping companies over the Internet.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram illustrating a flowchart-based industrial control system that includes an embedded controller that is coupled to devices that are associated with a process;

FIG. 2 is a functional block diagram of the flowchart-based industrial control system of FIG. 1 illustrated in further detail;

FIG. 3 illustrates transportation flowchart blocks of the flowchart-based industrial control system in an exemplary process; and

FIG. 4 is a block diagram illustrating exemplary steps performed by the transportation flowchart block.

### DETAILED DESCRIPTION OF THE PREFERRED EMBODIMENTS

The following description of the preferred embodiment(s) is merely exemplary in nature and is in no way intended to limit the invention, its application, or uses.

The present invention provides a flowchart-based industrial control system for industrial automation systems with specialized transportation flowchart blocks. The transportation flowchart blocks automates the shipping and tracking of goods to desired remote locations via shipping companies.

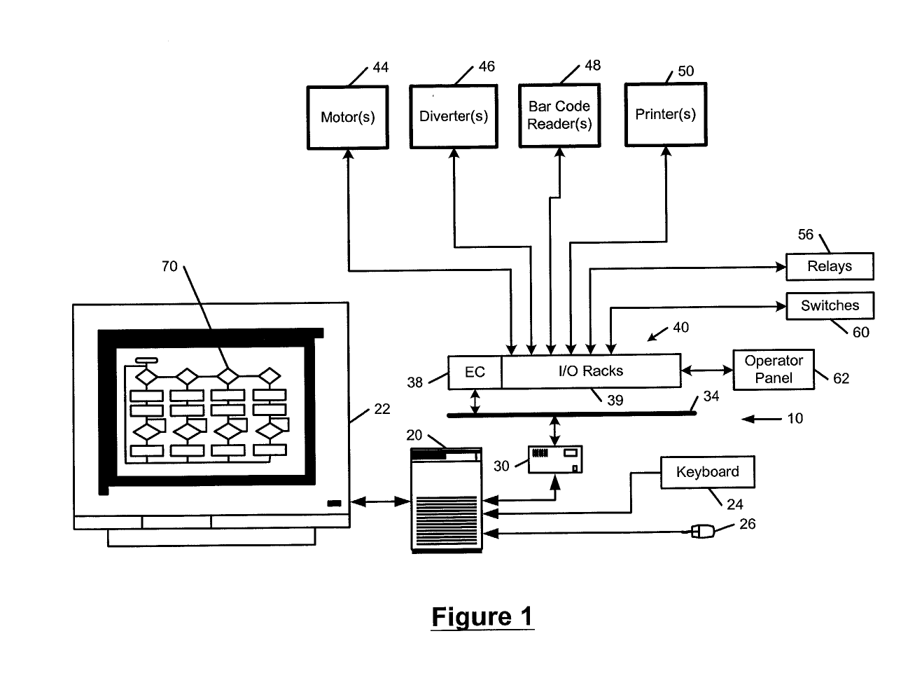

To illustrate the principals of the invention, the exemplary embodiment of FIG. 1 depicts an industrial control system 10 that includes a computer 20. A display 22, a keyboard 24 and a mouse 26 are connected to the computer 20. An input/output (I/O) card 30 such as an Ethernet card is connected in an expansion slot of the computer 20.

A communications or I/O network 34 such as an Ethernet network is connected to the I/O card 30. An embedded controller (EC) 38 is connected to the I/O network 34. Skilled artisans will appreciate that a simple communications interface can be substituted for the EC 38. I/O racks 39 are connected to the EC 38. Electrical and/or electromechanical devices are connected to the I/O racks 39. The exemplary devices include motor(s) 44, diverter(s) 46, bar code reader(s) 48, printer(s) 50, one or more relays 56, and one or more switches 60. The devices 44, 46, 48, 50, 56 and 60 are associated with a process. An operator panel 62 is optionally connected to the I/O racks 39. The operator panel 62 includes a multiple-line, character-based display. Skilled artisans can appreciate that other types of devices can be added to or substituted in the industrial control system 10 without departing from the spirit of the invention. In addition, the optional operator panel 62 can be connected to the EC 38 or the communications interface. Other I/O cards and networks are also contemplated.

The computer 20 contains a flowchart module that creates, edits, and displays flowcharts 70 on the display 22. The flowchart module generates source code that is compiled into object code directly from the flowchart. Flowchart modules providing such functionality are disclosed in U.S. Pat. No. 4,852,047 that was previously incorporated by reference.

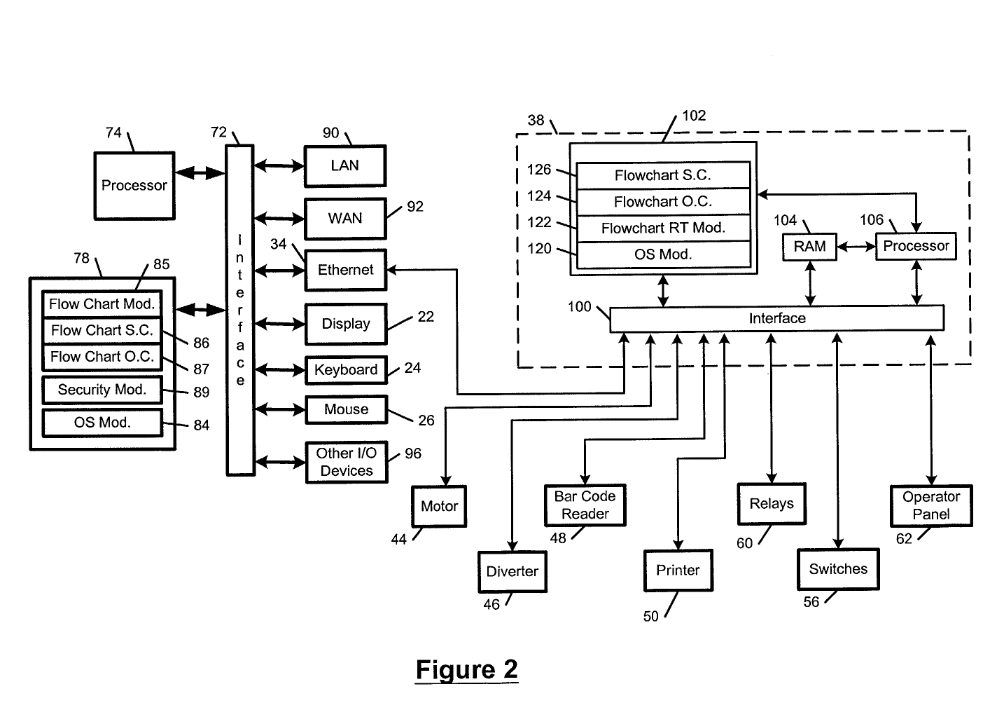

Referring now to FIG. 2, the industrial control system 10 is illustrated further and includes an I/O interface 72, a processor 74, and memory 78 including random access memory (RAM) and read-only memory (ROM). After boot-up, an operating system 84 such as Windows NT®, Windows NTE®, and Windows 2000®, or other suitable operating systems and a flowchart module 85 are loaded into the memory 78. The flowchart module 85 allows a user to create, edit and display the flowcharts 70. As the user generates the flowchart 70, the flowchart module 85 generates flowchart source code 86. When debugged and validated, the flowchart module 85 generates flowchart object code 87 that is generated from the flowchart source code 86. A security module 89 optionally provides password protection, encryption, or other security protocols to prevent unauthorized access.

The computer 20 is connected to a local area network (LAN) 90 and/or a wide area network (WAN) 94 which, in turn, can be connected to the Internet. One or more other I/O devices 96, such as a printer, scanner, etc., may also be connected to the I/O interface 72.

The EC 38 includes an I/O interface 100, ROM 102, RAM 104, and a processor 106. The operator panel 62 is connected to the I/O interface 100. The ROM 102 and/or RAM 106 contains an operating system 120 and a flowchart run-time module or kernel 122, and flowchart object code 124. Optionally, the flowchart source code can be compressed and transmitted to the EC 38. The EC 38 is preferably a Win PLC running Windows CEO. Preferably, the ROM 102 is flash ROM. The flowchart object code 87 is transmitted to the EC 38 through the I/O network 34 for execution by the flowchart run time module 122. If the communications interface is used for the EC 38, the flowchart object code 87 is preferably not loaded on the communications interface. The flowchart source code 86 is compressed by the computer 20 and transmitted via the I/O network 34 to the ROM 102 and/or RAM associated with the EC 38.

The flowchart module 85 separates out the optional operator panel 62 as another I/O port. The flowchart module 85 preferably addresses the I/O port that is associated with the operator panel 62 using the component object model (COM) without requiring the developer to write separate programs or drivers.

In use, a user launches the flowchart module 85 using the keyboard 24 and/or the mouse 26 when the user wants to create or to edit flowchart projects. The flowchart module 85 is loaded into the memory 78 of the computer. A user creates or edits the flowchart 70 for controlling the devices (the motor(s) 44, the diverter(s) 46, the bar code reader(s) 48, the printer(s) 50, the switches 60, and the relays 56) which are associated with the process as will be described further below. The user adds one or more transportation flowchart blocks to the flowchart 70 as will be described more fully below. The transportation flowchart blocks are preferably objects that can be selected using the conventional point and click method using a graphical user interface that is provided by the flowchart module 85.

As the user creates the flowchart 70 on the screen, the computer 20 generates the flowchart source code 86 that is then saved in the memory 78. After creation, debugging, and/or simulation is complete, the user compiles the flowchart source code 86 and generates the flowchart object code 87. The computer 20 compresses and transmits the flowchart object code 87 to the ROM 102 and/or RAM 104 associated with the EC 38 (illustrated at 124). Likewise, the flowchart object code 87 is optionally transmitted to the EC 38 (illustrated at 126). The flowchart run-time module 122 executes the flowchart object code 124 that controls the devices connected to the EC 38.

The present invention provides one or more specialized transportation flowchart blocks that automate the packaging and shipping of goods that are produced and/or shipped by the industrial control system. In the preferred embodiment, the transportation flowchart block allows low level controllers such as the EC 38 and/or the computer 20 to directly interface with shipping and tracking systems, such as those shipping and tracking systems provided by shipping companies such as Federal Express, UPS or the United States Postal Service.

Shipping companies such as Federal Express, UPS and the United States Postal Service now provide shipping information over the Internet. A manufacturer, purchaser or consumer can ship and/or track products by accessing the site and entering tracking codes. These shipping companies also provide an application protocol interface (API) that allows computer systems to directly make tracking inquiries, to obtain pricing, to fill out shipping labels and/or to obtain other information from the shipping company.

The present invention automates the shipping of finished goods without human intervention and tracks the shipping of the goods by supplying the shipping information (e.g., shipping cost and status of shipment data) to e-business systems of the manufacturer, seller, shipper and/or customer. Thus, the present invention directly integrates the function of transportation of the goods and collection of information with the industrial control system to automate the process.

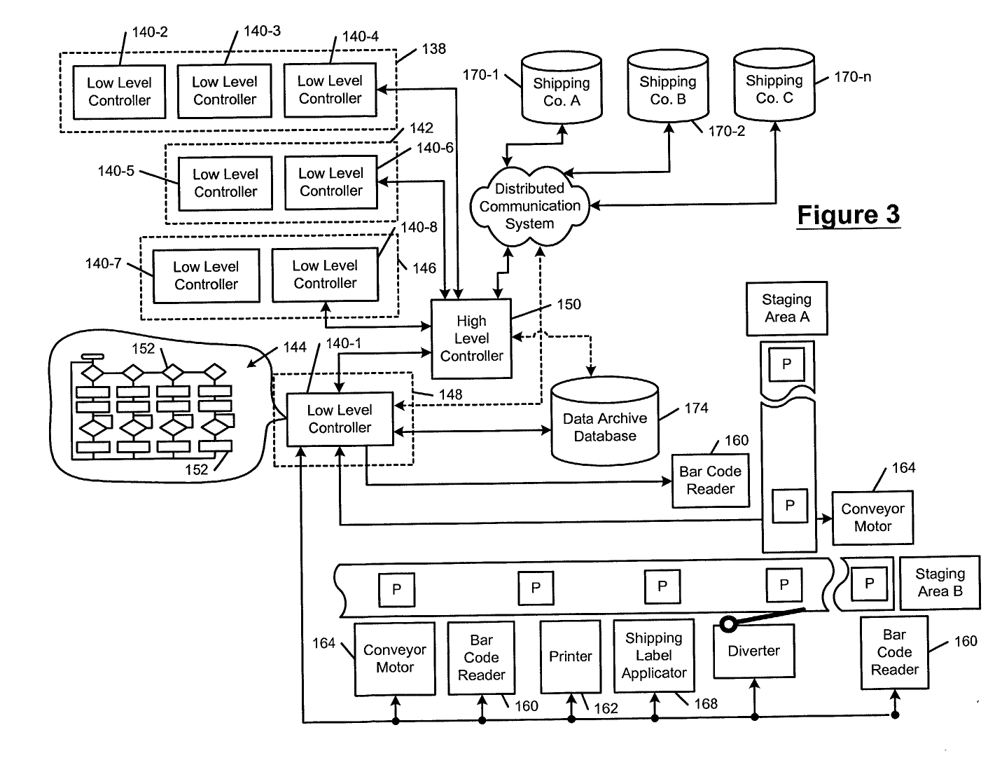

Referring now to FIG. 3, an exemplary implementation of a industrial control system 130 according to the present invention is shown. The industrial control system 130 includes a high level controller 134 that controls a process that includes one or more sub-processes that are in turn controlled by one or more low level controllers 140. For example, the high level controller 134 controls a first process 138 that is associated with low level controllers 140-2, 140-3, and 140-4. The high level controller 134 controls a second process 142 that is associated with low level controllers 140-5 and 140-6. The high level controller 134 controls a third process 146 that is associated with low level controllers 140-7 and 140-8. The high level controller 134 controls a fourth process 148 that is associated with one or more low level controllers 140-1. As can be appreciated, the number of low level controllers 140 and processes that are associated with the high level controller 134 can be increased or decreased without departing from the spirit of the invention.

In the exemplary embodiment, the fourth process 148 includes the low level controller 140-1 that runs flowchart-based control software that includes a flowchart 144 containing one or more transportation flowchart blocks 152. The transportation flowchart blocks control the transportation of the products, printing and affixing the shipping label and/or the collection of information. Briefly, the processing includes communicating (preferably via the Internet) with a remote shipping company in order to handle the shipping and billing, affixing a label onto boxes of the finished goods based upon the communication, and collecting and transmitting shipping information for reporting to a database.

The low level controller 140-1 directly operates one or more devices in the process. For example, the low level controller 140-1 controls one or more bar code readers 160, printers 162, conveyor motors 164, diverters 166 and shipping label applicators 168. Alternately, one or more additional low level controllers 140 can be associated with the process 148 and can be connected to the high level controller 150.

The high level controller 150 sends one or more instructions to one or more low level controllers and the low level controller(s) then implement more specific control instructions based upon the general instructions received from the high level controller. The low level controller 140 can be embedded directly in the machine that it is controlling or can be an embedded controller with an I/O rack that controls one or more devices. The migration of the transportation function from a high level controller to one or more low level controllers removes a significant amount of processing that the high level controller must do. Alternately, if enough processing power is available, the transportation function can be performed by the high level computer.

Because the transportation flowchart blocks 152 are preferably used within the low level controller 140, the transportation flowchart blocks 152 knows the immediate status of the finished goods. The low level controller 140 communicates with one or more remote shipping companies 170-1, 170-2, . . . , 170-n either directly over the Internet or through the high level controller 150 over the Internet to exchange shipping and labeling information. The low level controller 140 preferably communicates with one or more devices such as bar code readers 170 to identify the status of finished goods. The low level controller 140 also communicates with one or more databases 174 either directly or through the high level controller 150 to store and retrieve shipping and status information as needed.

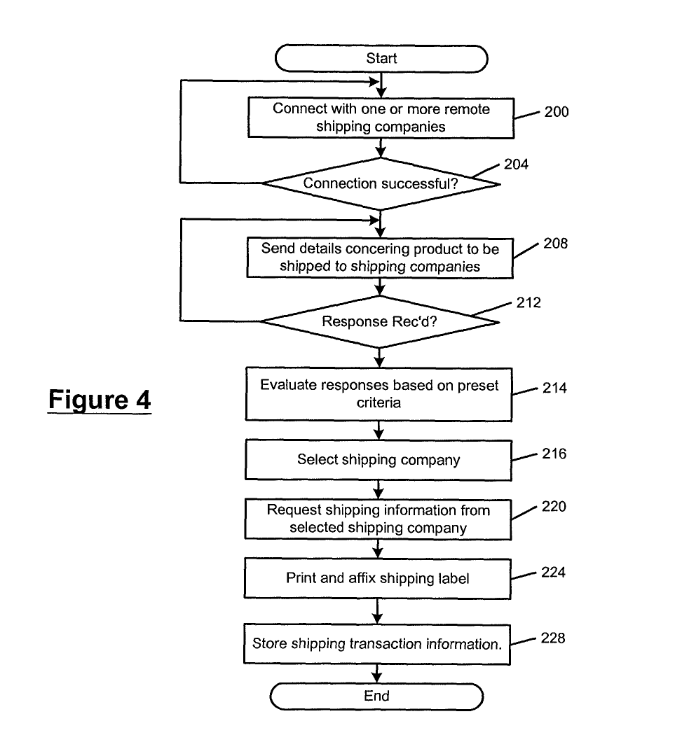

Referring now to FIG. 4, the steps that are performed by the transportation flowchart blocks 152 are shown. The specific ordering of the steps may be varied without departing from the spirit of the invention. In step 200, the transportation flowchart blocks connect to one or more remote shipping companies. In step 204, the high level or low level controller determines whether a connection has been made. Preferably the connection is made through the Internet. When the connection is made, details are transmitted in step 208 to the shipping companies as to the goods that need to be shipped. The details may also include the shipping characteristics of the goods such as the weight, the physical dimensions of the goods and the required date and time interval for shipping. In step 212, the responses from the companies are received. In step 216, the received information is processed via decision flowchart blocks. The decision flowchart blocks determine the companies that can perform the shipping, the companies that can ship the goods to the destination can within the preferred interval, and the company that offers the best price.

In step 220, shipping information is requested from the selected shipping company. This step may be combined with a prior step—for example the shipping information for printing the shipping label may be sent with the initial response from the shipping company. In step 224, the shipping label is printed via the printer 162. The shipping label contains the shipping information received from the company. The shipping label is affixed to the packaging containing the goods using the shipping label applicator 168. Alternately, the shipping label can be affixed prior to the information being printed.

For example, the low level controller knows (such as from the high level controller or the database) that a first package of goods needs to go to Nashville and performs the operations described above to get the goods there in the most efficient and cost-effective manner. For another package of goods, the low level controller knows that the item needs to go to Detroit and performs the operations described above to get the item to Detroit. In step 228, the low level controller transmits data to the data archive database 174 in order to store shipping transaction information related to the transportation operation. Such information includes but is not limited to the price to ship a certain item, the shipping company that was selected, the time that the package was ready to be shipped, the time that the package was shipped, etc.

The invention being thus described, it will be obvious that the same may be varied in many ways. Such variations are not to be regarded as a departure from the spirit and scope of the invention, and all such modifications as would be obvious to one skilled in the art are intended to be included within the scope of the present invention. For example, the present invention has many applications. Such applications include but are not limited to order fulfillment applications, such as shipping books and music CDs (compact discs).

What is claimed is:

1. A flowchart-based industrial control system that runs a process that involves transportation of goods, comprising:
a computer;
a controller connected to said computer;
a device that is connected to said controller; and
a flowcharting module run by said computer that generates and edits flowchart source code that includes flowchart blocks and that contains logic for operating said device to further said process, wherein at least one of said flowchart blocks is a transportation flowchart block that facilitates shipping of said goods.

2. The flowchart-based industrial control system of claim 1 wherein said transportation flowchart block contacts at least one shipping company and transmits shipping details concerning said goods.

3. The flowchart-based industrial control system of claim 2 wherein if a plurality of shipping companies are contacted, said transportation flowchart block evaluates responses from said shipping companies.

4. The flowchart-based industrial control system of claim 3 wherein if said plurality of shipping companies are contacted, said transportation flowchart block selects one of said shipping companies.

5. The flowchart-based industrial control system of claim 4 said transportation flowchart block requests shipping information for a shipping label from said selected shipping company.

6. The flowchart-based industrial control system of claim 5 wherein said device is at least one of an Internet communication link, a printer, a bar code reader, a conveyor motor, a shipping label applicator, and a diverter.

7. The flowchart-based industrial control system of claim 6 wherein said transportation flowchart block prints a shipping label using said printer with said shipping information from said selected shipping company.

8. The flowchart-based industrial control system of claim 7 wherein said transportation flowchart block applies said shipping label to said goods using said shipping label applicator.

9. The flowchart-based industrial control system of claim 1 wherein said flowchart source code is converted by said flowchart module to flowchart object code that is executed by said controller.

10. The flowchart-based industrial control system of claim 2 wherein said transportation flowchart block connects to said at least one shipping company over the Internet.

11. A method for transporting goods using a flowchart-based industrial control system, comprising:
using a flowchart module to generate and edit flowchart source code that includes flowchart blocks and that contains logic for operating a device to further a process; and
adding a transportation flowchart block to said flowchart that facilitates shipping of said goods.

12. The flowchart-based industrial control system of claim 11 further comprising converting said flowchart source code to flowchart object code that is executed by a controller.

13. The flowchart-based industrial control system of claim 11 further comprising contacting at least one shipping company and transmitting shipping details concerning said goods using said transportation flowchart block.

14. The flowchart-based industrial control system of claim 13 wherein said transportation flowchart block connects to said at least one shipping company over the Internet.

15. The flowchart-based industrial control system of claim 13 further comprising evaluating responses from said shipping companies using said transportation flowchart block.

16. The flowchart-based industrial control system of claim 15 further comprising selecting one of said shipping companies using said transportation flowchart block.

17. The flowchart-based industrial control system of claim 16 further comprising requesting shipping information for a shipping label from said selected shipping company using said transportation flowchart block.

18. The flowchart-based industrial control system of claim 17 wherein said device is at least one of an Internet communication link, a printer, a bar code reader, a conveyor motor, a shipping label applicator, and a diverter.

19. The flowchart-based industrial control system of claim 18 further comprising printing a shipping label with said shipping information from said selected shipping company using said printer.

20. The flowchart-based industrial control system of claim 19 further comprising applying said shipping label to said goods using said shipping label applicator.
